(19) United States
(12) Patent Application Publication
(10) Pub. No.: US 2011/0190030 A1
(43) Pub. Date: Aug. 4, 2011

(54) Cell phone with dual thermometer functionality

(75) Inventor: Kenneth P. Glynn, Flemington, NJ (US)

(73) Assignee: GlynnTech, Inc.

(21) Appl. No.: 12/658,064

(22) Filed: Feb. 2, 2010

(51) Int. Cl. H04M 1/00; G01K 13/00

(52) U.S. Cl. 455/556.1; 374/142; 374/E13.001

(57) ABSTRACT

A cell phone having dual temperature functionality includes: a) conventional wireless cell phone capability with hardware and software for storage of call data, a display screen and a power source; b) a dual functionality digital thermometer having a first mode for sensing environment temperature and a second mode for sensing human body temperature c) a digital thermometer control, including a selection mechanism for selecting said first mode or said second mode, and an activation mechanism to effect a temperature reading for the selected mode and to effect display of said temperature reading. The digital thermometer is located within and on the cell phone and connected to the display screen for digital display of temperature readings. Some embodiments of the cell phone with dual temperature functionality also include heart rate monitoring features.

### BACKGROUND OF INVENTION

a. Field of Invention

The invention relates generally to cell phones that are adapted to sense, store and transmit temperature information. The present invention cell phones have two modes for temperature readings. In one mode, the environment is monitored for ambient temperature. In a second mode, the human temperature is monitored for body temperature. The user may select or preset either mode and use the device in a broad temperature range (environment mode) for obtaining temperature outdoors, in a room, on a surface, etc. or in a narrow temperature range with more accuracy (human mode) for obtaining body temperature. Data may be stored, retrieved, transmitted, printed or sent to medical centers, doctors, home or business computers, etc. In other embodiments, heart monitoring features are also included.

b. Description of Related Art

The following patents are representative of the field pertaining to the present invention:

U.S. Pat. No. 7,614,001 B2 to Abbott et al describes techniques for creating, modifying, categorizing, modeling, distributing, purchasing, selling, and otherwise using themes and theme-related information. Themes can represent various types of contextual aspects or situations, and can model high-level concepts of activities or states not reflected in individual contextual attributes that each model a single aspect of the state of user, their computing device, the surrounding physical environment, and/or the current cyber-environment. Such themes, specify inter-relationships among a set of contextual attributes, and can have associated theme-related information such as theme-specific attributes, theme layouts used to present information and functionality, CSes that provide theme attribute values, and CCs that process theme information. Disclosed techniques can identify one or more themes that currently match the modeled context, select one of the matching themes as a current theme, and provide an appropriate response (e.g. by presenting appropriate information and/or providing appropriate functionality) based on the current theme.

U.S. Pat. No. 7,603,255 B2 to Case, Jr. et al. describes athletic performance monitoring systems and methods, many of which utilize, in some manner, global positioning satellite (“GPS”) data, and provide data and information to athletes and/or equipment used by athletes during an athletic event. Such systems and methods may provide route information to athletes and/or their trainers, e.g. for pre-event planning, goal setting, and calibration purposes. Such systems and methods optionally may provide real time information to the athlete while the event takes place, e.g., to assist in reaching the pre-set goals. Additionally, data and information collected by such systems and methods may assist in post-event analysis for athletes and their trainers, e.g., to evaluate past performances and to assist in improving future performances.

U.S. Pat. No. 7,426,405 B2 Lee describes a battery pack device with circuits for supporting additional functions such as a Karaoke function, a disease diagnosing function, and a skin beauty care function, and adapted to be detachably coupled to a mobile communication terminal, so as to perform the additional functions through the mobile communication terminal. The mobile communication terminal including the battery pack device is also disclosed. The battery pack device includes battery cells for supplying DC power to a body of the mobile communication terminal via power supply terminals, an additional circuit unit for providing additional functions to the terminal body, and a control unit for controlling an operation of the additional circuit unit while performing data transmission and reception with respect to an external device. The control unit includes an additional function processor for controlling the additional circuit unit, and a communication unit for performing data transmission and reception with respect to the terminal body.

U.S. Pat. No. 7,399,276 B1 Brown et al describes a remote health monitoring systems, as applied to the field of public health surveillance. In particular, it relates to a multi-user remote health monitoring system that is capable of reliably identifying and collecting data from frontline healthcare providers, laboratory and hospital information systems, patients and healthy individuals in a number of ways, with a view to aid in the field of public health. The system can also be used to query and collect additional information regarding specifics pertaining to the health of the individuals, and for patient tracking, monitoring, and the collection of individual data.

U.S. Pat. No. 7,397,357 B2 Krumm et al describes methods and systems that determine automatically the likelihood that a device is inside or outside of a structure or building. The system uses one or more sensors to detect ambient conditions, and make the determination. The inference can be used to save power or suppress services from certain devices, which are irrelevant, cannot be used effectively, or do not function under certain circumstances. In support thereof, the system includes one or more context sensors that measure parameters associated probabilistically with the context of a device. A context computing component considers one or more context sensors and facilitates determination of ideal actions, policies, and situations associated with the device. A service provided by the subject invention is the inference from one or more available observations the probability that the device is inside versus outside.

U.S. Pat. No. 7,327,245 B2 Krumm et al. describes the methods and systems that determine automatically the likelihood that a device is inside or outside of a structure or building. The system uses one or more sensors to detect ambient conditions, and make the determination. The inference can be used to save power or suppress services from certain devices, which are irrelevant, cannot be used effectively, or do not function under certain circumstances. In support thereof, the system includes one or more context sensors that measure parameters associated probabilistically with the context of a device. A context-computing component considers one or more context sensors and facilitates determination of ideal actions, policies, and situations associated with the device. A service provided by the subject invention is the inference from one or more available observations the probability that the device is inside versus outside.

U.S. Pat. No. 7,254,516 B2 to Case, Jr. et al. describes athletic performance monitoring systems and methods, many of them utilize, in some manner, global positioning satellite (“GPS”) data, provide data and information to athletes and/or to equipment used by athletes during an athletic event. Such systems and methods may provide route information to athletes and/or their trainers, e.g., for pre-event planning, goal setting, and calibration purposes. Such systems and methods optionally may provide real time information to the athlete while the event takes place, e.g., to assist in reaching the pre-set goals. Additionally, data and information collected by such systems and methods may assist in post-event analysis for athletes and their trainers, e.g., to evaluate past performances and to assist in improving future performances.

U.S. Pat. No. 7,229,385 B2 Freeman et al. describes a wearable device having a display element; display control circuitry connected to the display element; and a flexible body for supporting the display element, wherein the body is configured and sized to be secured onto a wearer, the body includes one or more components for maintaining an imparted configuration. In this way, for example, the body can be shaped into a configuration that will support the display element at a comfortable viewing angle

U.S. Pat. No. 7,212,111 B2 Tupler et al. describes the present embodiments to provide methods, systems and apparatuses for use in providing notification of emergency services as well as notifying additional individuals and/or groups of an emergency. Some embodiments provide methods for use in dispatching emergency services (136) and notifying one or more additional contacts. These methods wirelessly receive a request for emergency services from a remote wireless device, retrieve an emergency contact list according to the type of emergency and determine at least one emergency contact other than emergency services according to the contact list. Once identified, the contact is notified of the request for emergency services. Some embodiments further determine a mode of communicating with the emergency contact and notify the contact according to the mode of communication. Some methods additionally determine one or more types of emergency services to be dispatched and notify types of emergency services.

U.S. Pat. No. 7,096,731 B1 Lee describes a gripping force measuring a device that includes a housing having a pressure detecting device and having a handle portion for being held by a user, a trigger attached to the housing and engaged with the pressure detecting device for applying a pressing force against the pressure detecting device when the trigger is forced toward the pressure detecting device. A displayer may be used for displaying the pressing force applied against the pressure detecting device. The trigger includes an arm having a free end extended out of the housing, and a lever is attached to the housing and includes a free end extended out of the housing for allowing the arm to be gripped and forced toward the lever.

U.S. Pat. No. 6,954,657 B2 Bork et al describes a wireless device (100) having an optimum alert sequence definition to analyzes its environment, including time and type of incoming call, and select an appropriate alert signal sequence. A central processing unit included within the device is responsive to a transmitted signal from an external communications device to generate active and passive sonic sensing. The reflected signal received through the microphone and a predetermined set of values or ranges stored in memory coupled to the central processing unit are used as input for a program of instructions tangibly embodied in a programmable storage device executable by the central processing unit. Based upon processing of this reflected signal, the central processing unit determines which alert signal is optimum given the environment. The device may further include characterization of the environment based on processing of the ambient noise within the environment and several inputs including: manual inputs (user indication/selection), real time clock (including date), light sensing, temperature sensing, cellular receiver indications (RSSI and local network ID), motion sensing, caller identification, global positioning system data, and radio link reception (i.e. Bluetooth: office/home network, etc.).

U.S. Pat. No. 6,817,979 B2 Nihtilä describes a system and method to provide for interacting with a virtual physiological model of a user with use of a mobile communication device. Physiological data associated from the user. The physiological data is transmitted to the mobile communication device, preferably with use of a wireless communication protocol. The methodology further involves using the mobile communication device to communicate the physiological data to a network server. The physiological data is integrated into the virtual physiological model of the user. The user can access data and depictions of the user developed from the physiological data.

United States Patent Application Publication No. US 2007/0119248 A1 Lee describes a finger gripping force measuring device that includes a housing having a pressure detecting device, one or more knobs attached to the pressure detecting device for engaging with a finger of a user, and for allowing the finger of the user to apply a pressing force against the pressure detecting device with the knobs, and a displayer coupled to the pressure detecting device for receiving signals from the pressure detecting device and for displaying the pressing force applied against the pressure detecting device. The housing includes a circuit board coupled to the pressure-detecting device, for supporting the pressure-detecting device. A displayer may be used for displaying the pressing force applied against the pressure-detecting device. The trigger includes an arm having a free end extended out of the housing, and a lever is attached to the housing and includes a free end extended out of the housing for allowing the arm to be gripped and forced toward the lever.

United States Patent No. 2007/0119248 to Lee describes a finger gripping device includes a housing having a pressure detecting device, one or more knobs attached to the pressure detecting device for engaging with a finger or a user, and or displayer coupled to the pressure detecting device for receiving signals from the pressure detecting device and for displaying the pressing force applied against the pressure detecting device. The housing includes a circuit board coupled to the pressure-detecting device, for supporting the pressure-detecting device.

Notwithstanding the prior art, the present invention is neither taught nor rendered obvious thereby.

### SUMMARY OF INVENTION

The present invention is, in a first aspect, a cell phone having dual temperature functionality. It includes: a) a conventional wireless cell phone having at least basic calling out and call receiving functional components and having at least sufficient hardware and software for storage of call data, and having one display screen and at least one power source; b) a dual functionality digital thermometer having a first mode for sensing environment temperature and having a second mode for sensing human body temperature, the digital thermometer located within and on the cell phone and connected to the power source for power and to the at least one display screen for digital display of a temperature reading taken by the digital thermometer; c) a digital thermometer control means, including a selection mechanism for selecting the first mode or the second mode, and an activation mechanism to effect a temperature reading for the selected mode and to effect display of the temperature reading.

In some preferred embodiments of the present invention cell phone having dual thermometer functionality, the first mode includes a temperature range sensing capability of at least as low as 0° F. and as high as 120° F. and second mode includes a temperature range of 95° F. to 110° F.

In some preferred embodiments of the present invention cell phone having dual thermometer functionality, the temperature readings of the second mode are given to the nearest tenth of a degree.

In some preferred embodiments of the present invention cell phone having dual thermometer functionality, the digital thermometer control means also includes a selection mechanism for selecting one of degrees Fahrenheit and degrees Celsius.

In some preferred embodiments of the present invention cell phone having dual thermometer functionality, the cell phone further includes hardware and software for temperature reading data storage and retrieval. In some of these preferred embodiments of the present invention cell phone having dual thermometer functionality, this hardware and software includes cell phone display capability for the temperature reading data.

In some preferred embodiments of the present invention cell phone having dual thermometer functionality, the temperature reading data storage includes at least chronological data and temperature data for at least a predetermined number of readings.

In some preferred embodiments of the present invention cell phone having dual thermometer functionality, the hardware and software further includes wireless transmission of the temperature reading data to a designated wireless receiver.

In some other preferred embodiments of the present invention, a second aspect, the present invention cell phone has the aforedescribed dual thermometer functionality, and also has heart rate monitoring functionality. The invention includes: a) a conventional wireless cell phone having at least basic calling out and call receiving functional components and having at least sufficient hardware and software for storage of call data, and having one display screen and at least one power source; b) a dual functionality digital thermometer having a first mode for sensing environment temperature and having a second mode for sensing human body temperature, the digital thermometer being located within and on the cell phone and connected to the power source for power and to the at least one display screen for digital display of a temperature reading taken by the digital thermometer; c) a digital thermometer control means, including a selection mechanism for selecting the first mode or the second mode, and an activation mechanism to effect a temperature reading for the selected mode and to effect display of the temperature reading; d) a heart rate sensor having a microphone and sufficient hardware and software to receive heart rate data, and to provide heart rate data storage and retrieval.

In some preferred embodiments of the present invention cell phone having dual thermometer functionality and heart rate monitoring functionality, the first mode includes a temperature range sensing capability of at least as low as 0° F. and as high as 120° F. and second range of 95° F. to 110° F.

In some preferred embodiments of the present invention cell phone having dual thermometer functionality and heart rate monitoring functionality, the temperature readings of the second mode are given mode includes a temperature to the nearest tenth of a degree.

In some preferred embodiments of the present invention cell phone having dual thermometer functionality and heart rate monitoring functionality, the digital thermometer control means also includes a selection mechanism for selecting one of degrees Fahrenheit and degrees Celsius.

In some preferred embodiments of the present invention cell phone having dual thermometer functionality and heart rate monitoring functionality, the cell phone further includes hardware and software for temperature reading data storage and retrieval.

In some preferred embodiments of the present invention cell phone having dual thermometer functionality and heart rate monitoring functionality, the temperature reading data storage includes at least chronological data and temperature data for at least a predetermined number of readings.

In some preferred embodiments of the present invention cell phone having dual thermometer functionality and heart rate monitoring functionality, the hardware and software includes cell phone display capability for the temperature reading data.

In some preferred embodiments of the present invention cell phone having dual thermometer functionality and heart rate monitoring functionality, the hardware and software further includes wireless transmission of the temperature reading data to a designated wireless receiver.

In some preferred embodiments of the present invention cell phone having dual thermometer functionality and heart rate monitoring functionality, the heart rate data storage includes at least chronological data and heart rate data for at least a predetermined number of readings.

In some preferred embodiments of the present invention cell phone having dual thermometer functionality and heart rate monitoring functionality, the hardware and software includes cell phone display capability for heart rate data.

In some preferred embodiments of the present invention cell phone having dual thermometer functionality and heart rate monitoring functionality, the hardware and software further includes wireless transmission of the heart rate data to a designated wireless receiver.

In some preferred embodiments of the present invention cell phone having dual thermometer functionality and heart rate monitoring functionality, the hardware and software further includes capability to identify and report irregularities in heart rate readings.

In some preferred embodiments of the present invention cell phone having dual thermometer functionality and heart rate monitoring functionality, the software may be programmable so as to preset deviations for heart beat irregularities that will signal an alarm or a need for medical exam or treatment.

Additional features, advantages, and embodiments of the invention may be set forth or apparent from consideration of the following detailed description, drawings, and claims. Moreover, it is to be understood that both the foregoing summary of the invention and the following detailed description are exemplary and intended to provide further explanation without limiting the scope of the invention as claimed.

### BRIEF DESCRIPTION OF THE DRAWINGS

The accompanying drawings, which are included to provide a further understanding of the invention and are incorporated in and constitute a part of this specification, illustrate preferred embodiments of the invention and together with the detail description serve to explain the principles of the invention. In the drawings:

FIG. 1 is a schematic diagram of the present invention device showing functionalities for dual temperature readings;

FIG. 2 is a schematic diagram of the present invention device showing functionalities for dual temperature readings and heart monitoring;

FIG. 3 is a flow diagram for one embodiment of utilizing the present invention cell phone with dual temperature readings, and;

FIG. 4 is a flow diagram for one embodiment of utilizing the present invention cell phone with dual temperature readings and heart monitoring.

### DETAILED DESCRIPTION OF THE EMBODIMENTS

Cell phones have been integrated into society to benefit and ease everyday life. The invention of the cell phone has developed from a basic wireless telephone to a complex, hand-held device that has many of the capabilities of some computers. Cellular telephones have a variety of applications, including GPS systems, messaging centers, text and email capabilities, as well as customized users such as creating and storing grocery lists.

The present invention is directed to a unique cell phone involving healthcare, specifically a hand-held cell phone with a built-in dual thermometer and in some preferred embodiments, with a built-in dual thermometer heart monitoring device. With this said invention, a cellular phone can now act as a medical device that can wirelessly transmit important health information to doctors, hospitals, etc.

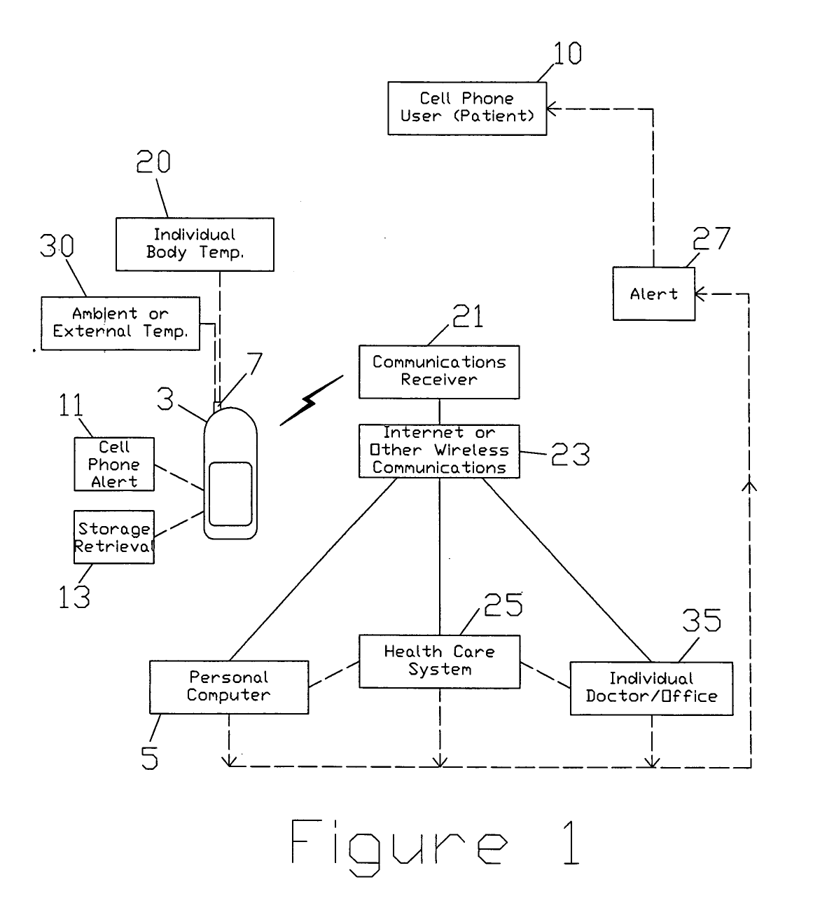

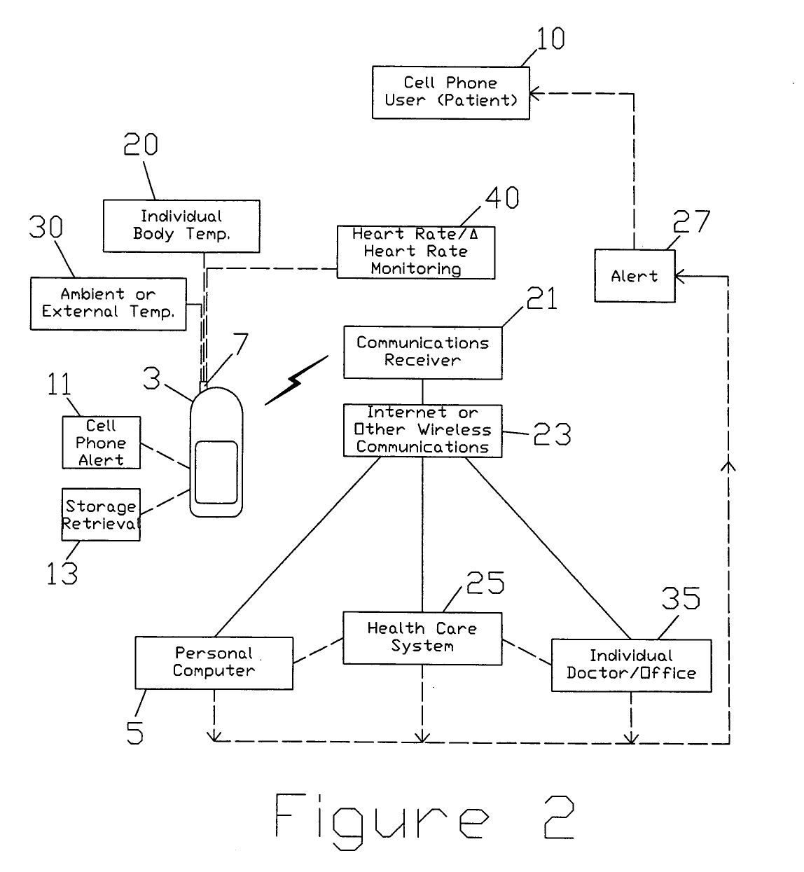

FIG. 1 and FIG. 2 are schematic diagrams of two preferred embodiments of the present invention hand-held cell phone 3. FIG. 1 shows one preferred embodiment that has a cell phone alert 11, and storage and retrieval capabilities 13 for dual temperature readings using a digital sensing device 7. FIG. 2 shows one preferred embodiment of the present invention that has cell phone alert 11, storage and retrieval capabilities 13 for dual temperature readings as well as for heart rate monitoring 40 using a sensing device 7.

In FIG. 1, the cell phone alert 11 may be used, but is not limited to one or more of the following, to alert user 10 to check temperature, alert user 10 that the temperature has been successfully read, alert user 10 that an error occurred while taking measurement, etc. The cell phone alert 11 can be a combination of, but is not limited to, a visual alert, e.g. a light or a blinking light, an audible alert, e.g. a loud sound or a series of sounds, or a physical alert, e.g. a vibration or series of vibrations, or combinations thereof. The cell phone alert 11 notifying the user 10 may be the same or different for each purpose of the alert.

The present invention has the capability of reading both individual body temperature 20 and ambient (external) temperature 30. The digital sensing device 7 will be able to measure both large and small temperature ranges and, in preferred embodiments, has an option for the user 10 to select the unit of the measurement, e.g. Celsius or Fahrenheit. In one preferred embodiment of the present cell phone invention 3, the temperature range may be dependent upon which mode is selected. If ambient (external) temperature 30 is selected, the digital sensing device 7 will be able to measure and record the surrounding temperature over a large temperature range, e.g. 0° F. to 120° F. If individual body temperature 20 is selected, the digital sensing device 7 may make a more precise reading over a smaller range, e.g. a range of 95° F. to 110° F. and the temperature measurement may be to the nearest tenth of a degree. In a preferred embodiment of the present invention, the cell phone digital sensing device 7 may have an unlimited range within its physical capabilities, and within that range, the level of accuracy is a matter of choice.

In FIG. 2, the cell phone alert 11 can be used, but is not limited, to any of the purposes previously mentioned that describes FIG. 1 or to one or more of the following, to alert user 10 to monitor heart rate, alert user 10 to store results, alert user 10 of an irregularity in heart rate, alert user 10 to wireless transmit readings to a medical office, etc. The cell phone alert 11 can be a combination of, but is not limited to, a visual alert, e.g. a light or a flashing light, an audible alert, e.g. a loud sound or a series of sounds, or a physical alert, e.g. a vibration or series of vibrations, or combinations thereof. The cell phone alert 11 notifying the user 10 may be the same or different for each purpose of the alert.

The preferred embodiment of the present invention has the capability of reading individual body temperature 20, ambient (external) temperature 30, and heart rate (change in heart rate) 40 monitoring. The digital sensing device 7 will be able to measure both large and small temperature ranges, and monitor a regular heart rate and any small deviations from the regular heart rate. One preferred embodiment of the present invention may have an option for the user 10 to select the unit of the measurement, e.g. Celsius, Fahrenheit, or Beats Per Minute. If ambient (external) temperatures 30 are selected, the digital sensing device 7 will be able to measure and record the surrounding temperature within a large temperature range, e.g. 0° F. to 120° F. If individual body temperature 20 is selected, the digital sensing device may make a more precise reading over a smaller range, e.g. 95° F. to 110° F., and the measurement may be to the nearest tenth of a degree, or some other predetermined level of accuracy. If heart rate (change in heart rate) monitoring 40 is selected, the digital sensing device 7 must be able to distinguish an irregularity in the heart rate pattern. If an irregularity, a change, or a series of changes in the heart rate are measured, the cell phone alert 11 may send a warning to the user 10 from the various alert methods previously discussed.

In both embodiments, the stored readings can be wireless transmitted to a communications receiver 21 and then transmitted to the Internet or other wireless communications 23. The storage and retrieval software 13 is well within the purview of one of ordinary skill in the art to create cell phone chips that include all of the features of the above said invention so that all of the software and hardware necessary to perform all of the present invention features described above and below may be included in the phone. Alternatively, necessary software and hardware may be stored in a host computer or server. Alternatively, necessary software and hardware may be stored in some other location. Alternatively, necessary software may be stored in a combination of the locations such as a chip, a host computer or server, and in some other location. Alternatively, the necessary software and hardware may be stored in a wireless third party provider outside of the Internet. The hardware and software is not limited to but can be stored in any combination thereof.

From there, the user 10 can, but is not limited to, send the data to a personal computer 5, a health care system 25, an individual doctor or office 35, etc. The user 10 may choose to send the records to a personal computer 5 for personal use, e.g. to save health records and monitor changes from past recording, etc. If the data is sent to a Health Care System 25, the transmitted recordings are not limited to but may be used to save for records, to forward to a specialist, or may procure a request for further action. If the data is sent to an individual doctor or office 35, the transmitted recordings are not limited to but may be used for a quicker examination for fast results, or may determine if a user follow up if necessary. Depending on the results of the measured data, an alert 27 may be released and sent back to the user (patient) 10 by methods previously discussed. The alert 27 may be used to signal to the user 10 that one or more of the following should be noted: further readings may be required, the user 10 should seek medical attention, the user 10 recorded normal results, etc.

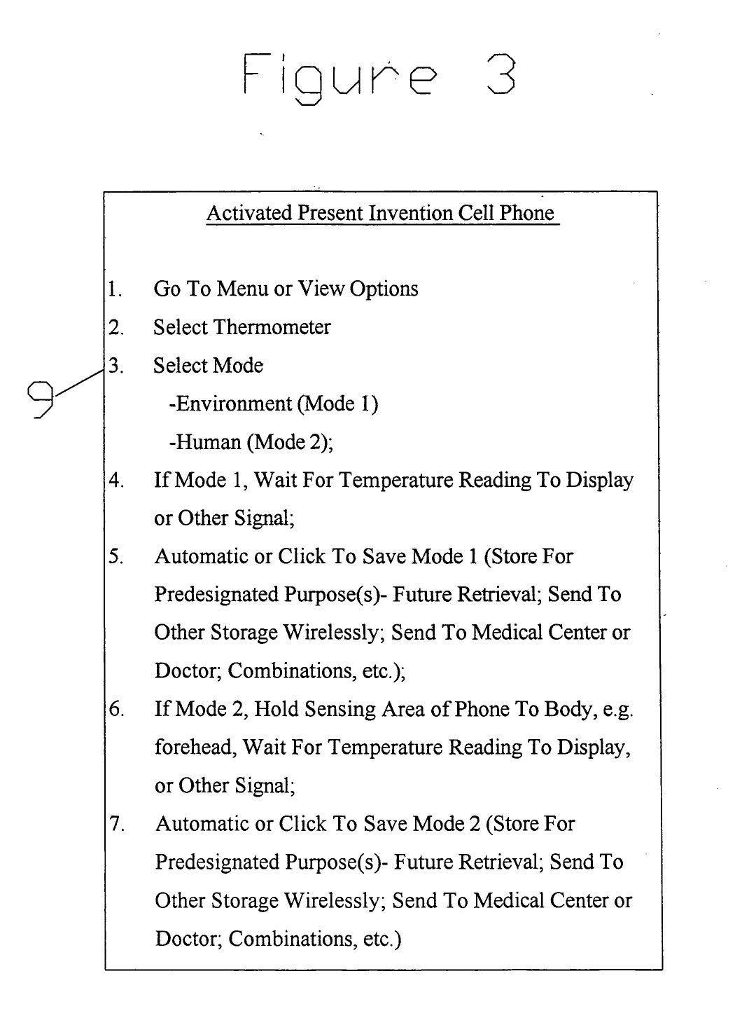

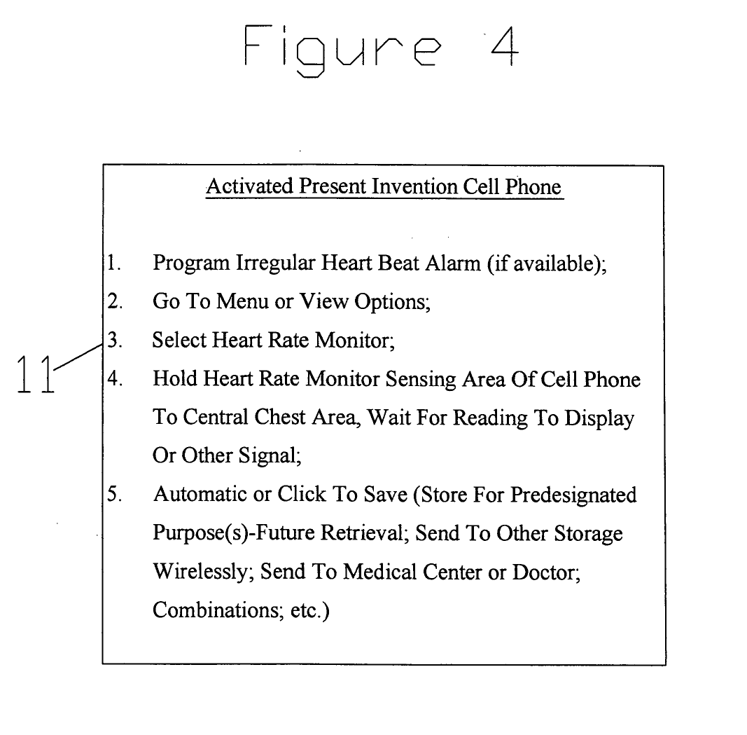

FIG. 3 and FIG. 4 are two preferred embodiments of the present Invention Cell Phone software interface. FIG. 3 shows one preferred embodiment of the user interface available for a cell phone with a digital sensing device and dual thermometer reading capabilities. FIG. 4 shows another preferred embodiment of the user interface available for a cell phone with a digital sensing device and both dual thermometer and heart monitoring capabilities.

The preferred embodiment of the user interface 9 can be activated by a variety of methods that already exist but are not limited to; voice command, touch screen, or manual input. Using any of these methods to select the menu, the user may view the available options and a set of directions for proper use of the dual thermometer function. Once the user selects the desired thermometer mode and units, a set of directions is displayed to the user, e.g. where to place the present invention, how to position the present invention, how to start and stop the recording, and for what duration to hold the present invention. The directions and options may be given to the user by a variety of methods that currently exist, but are not limited to; voice command, visual directions, etc. and, in preferred embodiments, may have an alert to signal to the user when the device will start and stop recording. The alert can be any a combination of, but is not limited to, a visual alert, e.g. a light or a blinking light, an audible alert, e.g. a loud sound or a series of sounds and beeps, or a physical alert, e.g. a vibration or series of vibrations. The alerts may be the same or different depending upon the results of the recording, e.g. a warning alarm (versus a standard alarm) may sound if results are irregular. The dual temperature measurement may determine the temperature using existing methods, which are unimportant to the present invention.

The preferred embodiment of the user interface 11 can be activated by a variety of methods that already exist but are not limited to; voice command, touch screen, or manual input. Using any of these methods to select the menu, the user may view the available options and a set of directions for proper use of the dual thermometer and heart monitoring functions. In a preferred embodiment the user may be able to select a custom warning alarm from a selection of alarms that may be available from the given software. The warning alarm would make the user aware of an irregularity in the recorded data. If the user chooses the heart monitoring option, a set of directions is displayed to the user, e.g. where to place the present invention, how to position the present invention, how to start and stop the recording, and for what duration to hold the present invention. Like the other preferred embodiment, the directions and options may be given to the user by a variety of methods that currently exist, but are not limited to voice command, visual directions, etc. In a preferred embodiment, the present invention may have an alert to signal to the user when the device will start and stop recording. The alert can be any a combination of, but is not limited to, a visual alert, e.g. a light or a blinking light, an audible alert, e.g. a loud sound or a series of sounds and beeps, or a physical alert, e.g. a vibration or series of vibrations. The alerts may be the same or different depending upon the results of the recording, e.g. a warning alarm (versus a standard alarm) may sound if the measured results are irregular. The heart rate monitoring software may determine the heart rate and change in heart rate based on existing methods, which are unimportant to the present invention.

After the reading has been taken, the user, in some preferred embodiments, may have the options to save the recording, delete the recording, or store the recording for a pre-designated purpose. The storage and retrieval software on the cellular phone allows the user to store and retrieve a predetermined number of recordings for any of the pre-designated purposes. The purposes may be, but are not limited to, future retrieval, wireless transmission of data to other storage device, wireless transmission of data to a medical center or doctor, or any combination of the stated uses. In a preferred embodiment of the cell phone invention, the user may change the number of pre-determined stored readings in an options menu.

What is claimed is:

1. A cell phone having dual thermometer functionality, which comprises:
a) a conventional wireless cell phone having at least basic calling out and call receiving functional components and having at least sufficient hardware and software for storage of call data, and having one display screen and at least one power source;
b) a dual functionality digital thermometer having a first mode for sensing environment temperature and having a second mode for sensing human body temperature, said digital thermometer being located within and on said cell phone and connected to said power source for power and to said at least one display screen for digital display of a temperature reading taken by said digital thermometer;
c) a digital thermometer control means, including a selection mechanism for selecting said first mode or said second mode, and an activation mechanism to effect a temperature reading for the selected mode and to effect display of said temperature reading.

2. The cell phone of claim 1 wherein said first mode includes a temperature range sensing capability of at least as low as 0° F. and as high as 120° F. and second mode includes a temperature range of 95° F. to 110° F.

3. The cell phone of claim 1 wherein temperature readings of said second mode are given to the nearest tenth of a degree.

4. The cell phone of claim 1 wherein said digital thermometer control means also includes a selection mechanism for selecting one of degrees Fahrenheit and degrees Celsius.

5. The cell phone of claim 1 wherein said cell phone further includes hardware and software for temperature reading data storage and retrieval.

6. The cell phone of claim 5, wherein said hardware and software includes cell phone display capability for said temperature reading data.

7. The cell phone of claim 5 wherein said temperature reading data storage includes at least chronological data and temperature data for at least a predetermined number of readings.

8. The cell phone of claim 5, wherein said hardware and software further includes wireless transmission of said temperature reading data to a designated wireless receiver.

9. A cell phone having dual thermometer functionality and heart rate functionality, which comprises:
a) a conventional wireless cell phone having at least basic calling out and call receiving functional components and having at least sufficient hardware and software for storage of call data, and having one display screen and at least one power source;
b) a dual functionality digital thermometer having a first mode for sensing environment temperature and having a second mode for sensing human body temperature, said digital thermometer being located within and on said cell phone and connected to said power source for power and to said at least one display screen for digital display of a temperature reading taken by said digital thermometer;
c) a digital thermometer control means, including a selection mechanism for selecting said first mode or said second mode, and an activation mechanism to effect a temperature reading for the selected mode and to effect display of said temperature reading;
d) a heart rate sensor having a microphone and sufficient hardware and software to receive heart rate data, and to provide heart rate data storage and retrieval.

10. The cell phone of claim 9 wherein said first mode includes a temperature range sensing capability of at least as low as 0° F. and as high as 120° F. and second mode includes a temperature range of 95° F. to 110° F.

11. The cell phone of claim 9 wherein temperature readings of said second mode are given to the nearest tenth of a degree.

12. The cell phone of claim 9 wherein said digital thermometer control means also includes a selection mechanism for selecting one of degrees Fahrenheit and degrees Celsius.

13. The cell phone of claim 9 wherein said cell phone further includes hardware and software for temperature reading data storage and retrieval.

14. The cell phone of claim 13, wherein said temperature reading data storage includes at least chronological data and temperature data for at least a predetermined number of readings.

15. The cell phone of claim 13, wherein said hardware and software includes cell phone display capability for said temperature reading data.

16. The cell phone of claim 13, wherein said hardware and software further includes wireless transmission of said temperature reading data to a designated wireless receiver.

17. The cell phone of claim 9, wherein said heart rate data storage includes at least chronological data and heart rate data for at least a predetermined number of readings.

18. The cell phone of claim 9, wherein said hardware and software includes cell phone display capability for heart rate data.

19. The cell phone of claim 9, wherein said hardware and software further includes wireless transmission of said heart rate data to a designated wireless receiver.

20. The cell phone of claim 13, wherein said hardware and software further includes capability to identify and report irregularities in heart rate readings.
